(19) United States
(12) Patent Application Publication
(10) Pub. No.: US 2019/0252934 A1
(43) Pub. Date: Aug. 15, 2019

(54) MOTOR ROTOR WITH HOLES

(71) Applicant: NEW WIDETECH INDUSTRIES CO., LTD., New Taipei City (TW)

(72) Inventors: Ming Tsung CHIU, New Taipei City (TW); Jui An CHIANG, New Taipei City (TW); Chung Ming LIN, New Taipei City (TW); Yao Yang HSIEH, New Taipei City (TW)

(21) Appl. No.: 15/894,937

(22) Filed: Feb. 13, 2018

(51) Int. Cl. H02K 1/27

(52) U.S. Cl. CPC H02K 1/2766

(57) ABSTRACT

A rotor for a brushless motor has a main body and multiple magnet assemblies. The main body has multiple first holes that extend in a bending shape. The first holes are arranged annularly and a bent corner portion of each first hole is closer to the rotation axis of the main body. Each magnet assembly has two magnets formed as a rectangular block and is mounted in one of the first holes. An angle is between the magnets and an air interval is formed between the magnets. With such a structure, a conventional curved magnet is substituted and magnetic lines of force are more concentrated, so a stator tooth can provide higher magnetic flux density. Especially, with the air interval, the magnetic flux leakage may be decreased. Consequently, even though the total weight of magnets is reduced, the efficiency of motor is still improved.

### BACKGROUND OF THE INVENTION

### 1. Field of the Invention

The present invention relates to a rotor for a motor, especially to a rotor including permanent magnets and used for a brushless motor.

### 2. Description of the Prior Arts

A brushless motor can convert electricity to kinetic energy with coils mounted on a stator and with permanent magnets mounted on a rotor. After energized with electricity, the coils generate magnetic fields and thus the permanent magnets can be driven to rotate through the variation of the magnetic fields.

Please refer to FIG. 6. A conventional rotor 91 has a main body 911, a plurality of receiving holes 912 formed through the main body 911 in a lengthwise direction of the main body 911. The receiving holes 912 are annularly arranged apart from each other. Each one of the receiving holes 912 receives a curved magnet 92, and the curved magnet 92 is a permanent magnet. A side surface of each one of the curved magnets 92 far from a rotating axis of the main body 911 is a curved surface, and another side surface of said curved magnet 92 that faces to the rotating axis of the main body 911 is a plane surface. An ideal motor should have a lower weight and a higher efficiency, but the aforementioned rotor for a motor has the following defects.

First, a volume of each magnet 92 is big and a weight of each magnet 92 is heavy, so the cost is high as well.

Second, the cogging torque is one of the main factors relating to noise and vibration of the motor, and the cogging torque is affected by types of the rotor and arrangement of the magnets 92. However, the conventional structure of the rotor 91 and magnets 92 may increase the cogging torque, so the noise and vibration generated by the motor are significant.

Third, the curved magnet 92 with a curved surface is hard to be manufactured, so the cost of the motor is further higher.

Fourth, the main body 911 of the rotor 91 forms the receiving holes 912 for the curved magnets 92, so a thickness between an outer surface of the main body 911 and a curved surface of each receiving hole 912 is thin, which causes accuracy requirements for manufacturing the conventional rotor 91 is high and thereby expenditures for manufacture and maintenance are high. Besides, the thin thickness may be broken easily, so the lifetime of the conventional rotor 91 is short.

To overcome the shortcomings, the present invention provides a motor rotor with holes to mitigate or obviate the aforementioned problems.

### SUMMARY OF THE INVENTION

The main objective of the present invention is to provide a motor rotor with holes that uses two magnets to substitute one conventional curved magnet, and thereby the weight of the total magnets in the rotor may be reduced and the manufacture of the rotor is simplified so that the cost of manufacture is also reduced. Besides, with such an arrangement, the cogging torque is lesser than that of a conventional rotor, and thereby the efficiency of the motor is improved and the vibration and noise are reduced.

The rotor has a main body and a plurality of magnet assemblies. The main body is a cylinder comprises a plurality of first holes. The first holes are formed through the main body and annularly arranged apart from each other. An axis of each one of the first holes is parallel with a rotating axis of the main body. Each one of the first holes integrally is formed and extends in a bending shape, and comprises two arm portions, a bent corner portion, and an air interval. The bent corner portion is between the two arm portions and closer to the rotating axis of the main body than the two arm portions. The air interval is in the bent corner portion. The magnet assemblies are mounted through the first holes respectively. Each one of the magnet assemblies comprises two magnets mounted in the corresponding first hole, spaced apart by the bent corner portion of the corresponding first hole, and forming an angle between the two magnets, the angle between the two magnets is equal to an angle of the bent corner portion of the first hole.

With the first hole forming a corner and the two magnets mounted in the first hole corresponding to the corner, the single conventional curved magnet is substituted. In the present invention, the multiple first holes are arranged in the shape of a star and thereby the magnetic lines of force are more concentrated, which causes the magnetic flux density at a stator tooth to increase. Therefore, in the present invention, the smaller magnets still provide equal or higher magnetic flux density than the conventional curved magnet, so a total weight of magnets and a total weight of the rotor are lessened, and the cost of manufacturing the rotor is reduced. Besides, with the magnets arranged in the shape of a star, the rotor has the following advantages: (1) back electromotive force is increased; (2) cogging torque of the motor is lessened and thus the noise and the vibration are also lessened. Thus, even though the total weight of the magnets is reduced, the efficiency of the motor is still improved in the present invention.

### BRIEF DESCRIPTION OF THE DRAWINGS

FIG. 1 is a perspective view of a rotor in accordance with the present invention;

FIG. 2 is a front view of the rotor in FIG. 1;

FIG. 3 is a perspective view of the rotor in FIG. 1 disposed in a stator and shown with magnetic lines of force;

FIG. 4 is a graph showing back electromotive forces in accordance with the present invention and a conventional rotor with curved magnets.

FIG. 5 is a graph showing cogging torque in accordance with the present invention and the conventional rotor with the curved magnets.

FIG. 6 is a front view of the conventional rotor; and

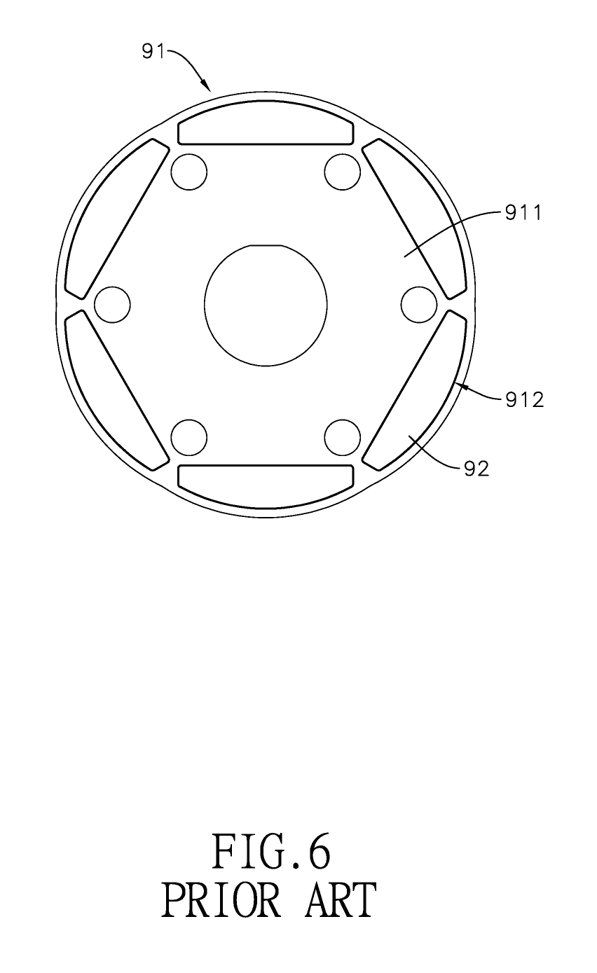

FIG. 7 is a perspective view of the conventional rotor in FIG. 6 disposed in a stator and shown with magnetic lines of force.

### DETAILED DESCRIPTION OF THE PREFERRED EMBODIMENTS

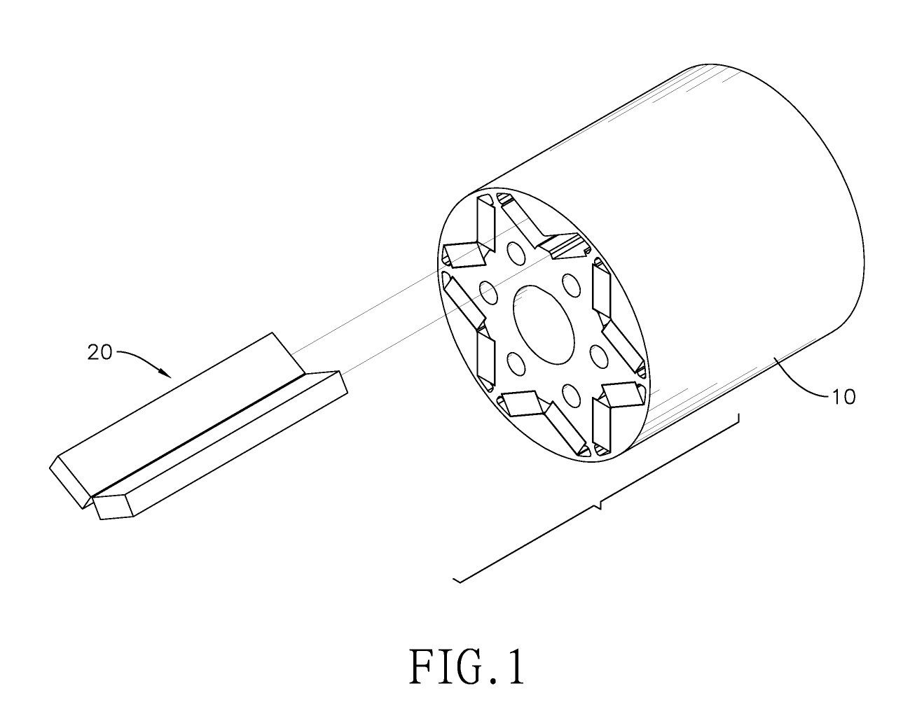

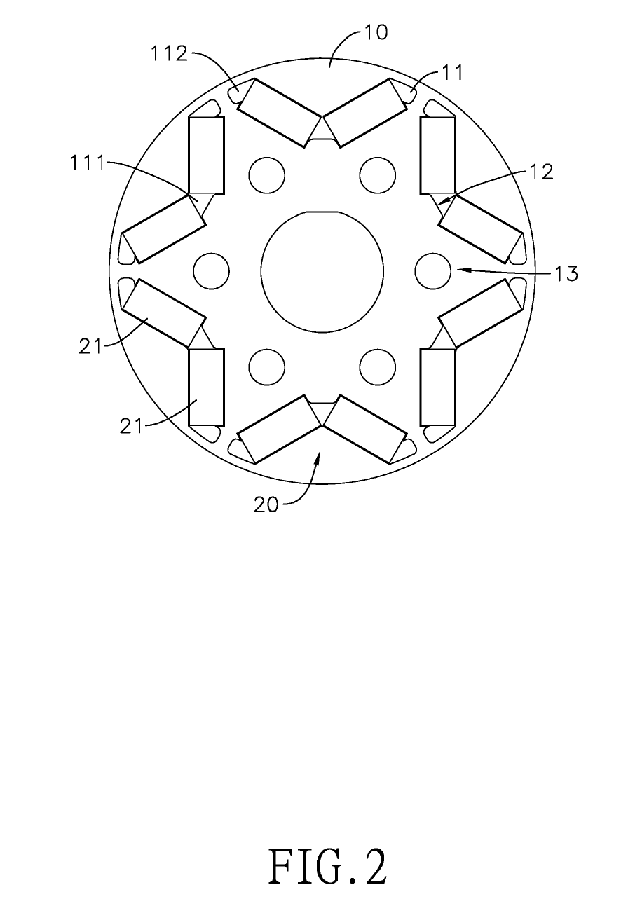

With reference to FIGS. 1 to 3, a rotor in accordance with the present invention is provided for a motor, and the rotor comprises a main body 10 and a plurality of magnet assemblies 20. During operation, the rotor is mounted in a stator 30 with an interval enclosing the rotor.

The main body 10 is, but not limited to, a cylinder. The main body 10 may not be a cylinder with a perfectly smooth surface, and an outer surface of the main body 10 may form multiple protrusions. In another embodiment, if the main body 10 can rotate in the stator 30 stably, the main body 10 may be in any shape, such as a polygonal column.

The main body 10 includes a plurality of first holes 11 formed through the main body 10. An axis of each one of the first holes 11 is parallel with a rotating axis of the main body 10. Each one of the first holes 11 integrally extends in a bending shape. The term “integrally” means when the rotor is viewed from a front view, each first hole 11 is a space with nothing therein for dividing the first hole 11 into separated parts. The first holes 11 are arranged annularly on the main body 10. Each one of the first holes 11 comprises two arm portions and a bent corner portion, and the bent corner portion is between the two arm portions, or, in a V shape. The bent corner portion is closer to the rotating axis of the main body 10 than the two arm portions. In this embodiment, the main body 10 has six first holes 11 arranged annularly, so the six first holes 11 may form a hexagram, but it is not limited thereto. The main body 10 may have eight first holes 11 arranged annularly in the shape. Besides, each one of the first holes 11 comprises a protrusion 12. The protrusion 12 is formed on an inner wall of the first hole 11 at the bent corner portion of the first hole 11. Precisely, the protrusion 12 is located at a side of the bent corner portion that is closer to the rotating axis of the rotor, but it is not limited thereto.

An angle of the bent corner portion of each first hole 11 may range from 117 to 123 degrees, and further, in this embodiment, the angle is 120 degrees. The main body 10 further comprises a plurality of second holes 13. Each one of the second holes 13 is formed through the main body 10. An axis of each one of the second holes 13 is parallel with the rotating axis of the main body 10. Because the second holes 13 are used for connecting to the rotating axis, the second holes 13 may not be parallel with the rotating axis and may not be formed through the main body 10. In addition, the second holes 13 are arranged closer to the rotating axis of the main body 10 than the first holes 12.

The magnet assemblies 20 are mounted through the first holes 11 respectively. Precisely, each one of the magnet assemblies 20 comprises two magnets 21 and thus an angle is formed between the two magnets 21. The angle between the two magnets 21 equals to an angle of the bent corner portion of the first hole 11. In this embodiment, the two magnets 21 are mounted through the two arm portions of the corresponding first hole 11. Besides, each one of the first holes 11 further comprises an air interval 111. The air interval 111 is between adjacent ends of the two magnets 21 of the corresponding magnet assembly 20 and at the bent corner portion of the corresponding first hole 11. Precisely, with each one of the magnet assemblies 20 mounted in the respective one of the first holes 11, the protrusion 12 of said first hole 11 abuts the two magnets 21 of said magnet assembly 20, and thereby the air interval 111 is formed between the two magnets 21 and the protrusion 12. Besides, each one of the first holes 11 further comprises two air gaps 112, and the two air gaps 112 are formed at two ends of the corresponding magnet assembly 20. In other words, each one of the first holes 11 is not filled up with the corresponding magnet assembly 20 and after the magnet assembly 20 is mounted in the first hole 11, the air gaps 112 are formed between the inner wall of the first hole 11 and the two ends of the magnet assembly 20.

In this embodiment, each magnet 21 is a rectangular block, but it is not limited thereto, as the shape of each magnet 21 should allow the magnet 21 to be mounted through the first hole 11 and a cost of manufacturing the magnet 21 is reduced.

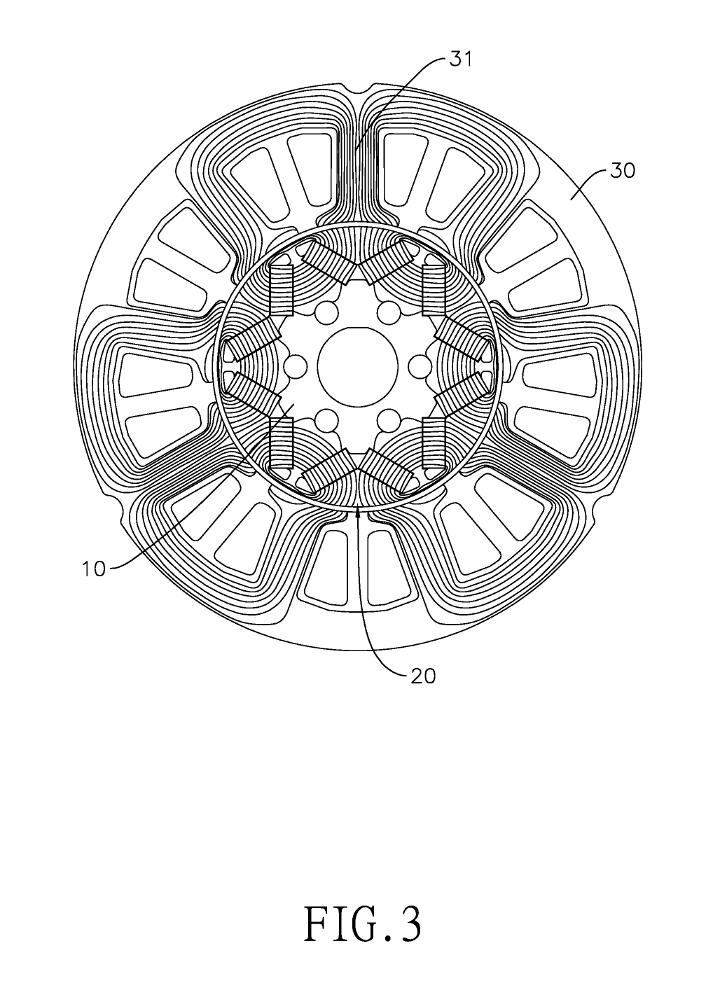

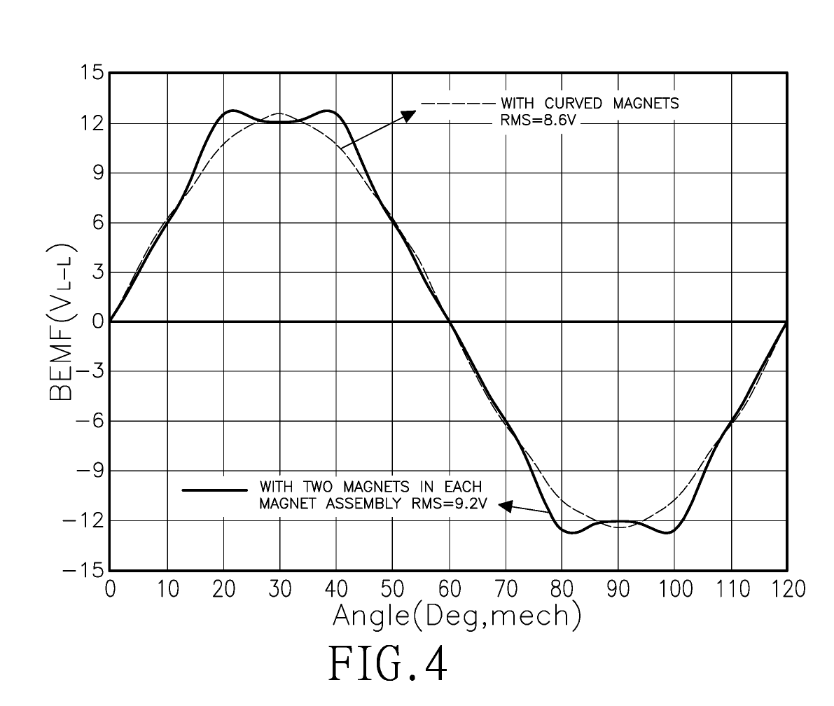

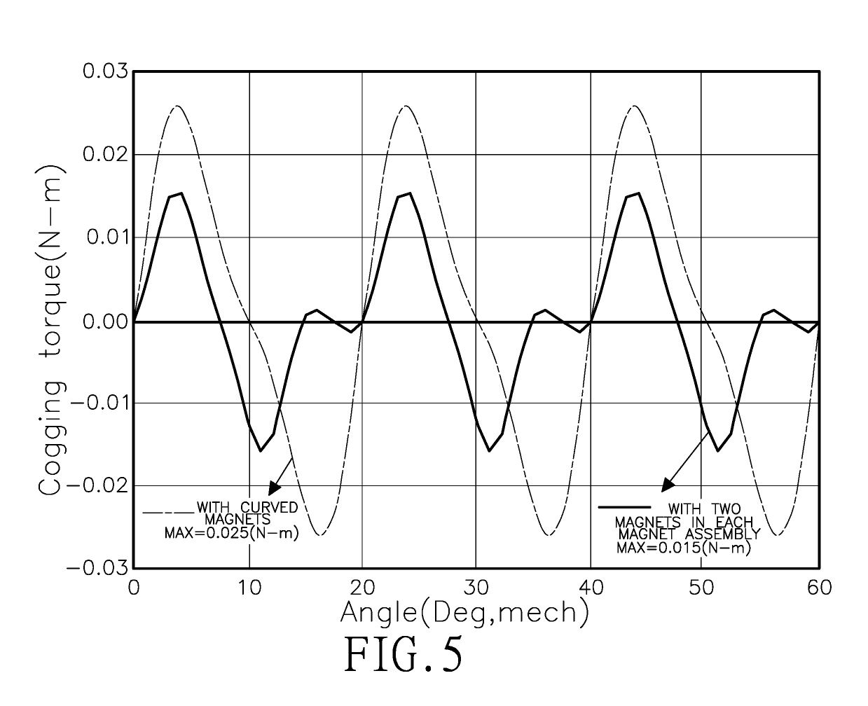

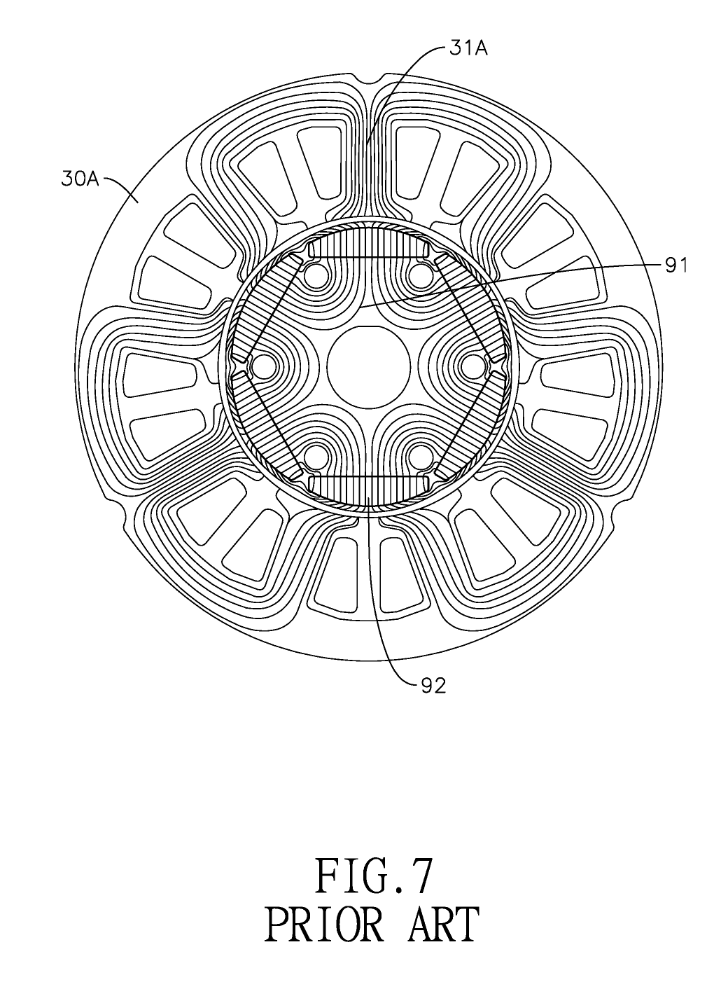

As shown in FIG. 3, during operation, the main body 10 is mounted in the stator 30 with the interval therebetween. Please also refer to FIG. 7, which shows the conventional curved magnet 92. In the present invention, with each magnet assembly 20 having the two magnets 21, magnetic lines of force of the stator tooth 31 of the present invention shown in FIG. 3 may be more concentrated in comparison with the conventional stator tooth 31A shown in FIG. 7. Therefore, the concentrated magnetic lines of force may provide higher magnetic flux density. In the present invention, the magnetic flux density at the stator tooth 31 is 1.55 Tesla, but the magnetic flux density at the conventional stator tooth 31A is 1.45 Tesla. Thus, with higher magnetic flux density, the present invention has higher back electromotive force as shown in FIG. 4. An equivalent value (which is a root mean square of magnetic flux density) of the two magnets 21 in one magnet assembly 20 in the present invention is larger than that of the curved magnet in a conventional rotor. Furthermore, the appropriate structure of the rotor and the magnet can lessen the cogging torque as shown in FIG. 5. Therefore, a maximum of the cogging torque generated by the two magnets 21 in one magnet assembly 20 in the present invention is less than that of the curved magnet in a conventional rotor. With the aforesaid structures, the rotor of the present invention may reduce the volume and weight of the magnet but still improve the efficiency of the motor. Precisely, with the bent corner portion of each first hole 11 bent at an angle ranging from 117 degrees to 123 degrees, the weight of each magnet 21 may be reduced by 7.4 grams to 8.1 grams, approximately 26.9% to 29.4%, depending on the angle of the bent corner portion.

Consequently, with the air interval 111 and the air gap 112 as barriers, the magnetic lines of force are prevented from leaking from the magnetic circuit and thus are more concentrated. Therefore, even though the total weight of magnets is reduced, the magnets still provide equal or higher magnetic flux density, so that the efficiency of the motor is still improved. Besides, with such arrangement, the cogging torque of the motor is lessened and thus the noise and the vibration are also lessened.

Another advantage of the rotor of the present invention, comparing with the conventional rotor that has walls with thin thicknesses aside the curved receiving hole for the curved magnets, the rotor of the present invention does not include any thin wall in the main body 10, so the main body 10 for stamping and manufacturing, and the mold for the main body 10 may not be damaged and the cost of manufacture is decreased.

Experimental data of a motor with a rotor according to the present invention or a conventional rotor are shown as follows:

Data of a motor with a conventional rotor comprising curved magnets:

| | | | | | | | | | |
|---|---|---|---|---|---|---|---|---|---|
| | Rotation | | | | Input | Output | Driving | Motor | Overall |
| | Speed | Torque | Voltage | Current | Power | power | Efficiency | Efficiency | Efficiency |
| Item | (rpm) | (TQ, N-m) | (Vav) | (Iav) | (Pi) | (Po) | (Eff) | (Eff) | (Eff) |

Load Test: Rotation Speed Variation 2.0 kg-cm

| | | | | | | | | | |
|---|---|---|---|---|---|---|---|---|---|
| 1 | 1800 | 0.201 | 5.71 | 5.1 | 55 | 37.9 | 89.9 | 76.6 | 68.8 |
| 2 | 2100 | 0.204 | 6.51 | 5.2 | 63 | 44.8 | 90.8 | 78.1 | 70.9 |
| 3 | 2400 | 0.206 | 7.31 | 5.3 | 71 | 51.7 | 91.5 | 79.4 | 72.6 |
| 4 | 2700 | 0.208 | 8.08 | 5.4 | 79 | 58.8 | 92.1 | 80.7 | 74.4 |
| 5 | 3000 | 0.209 | 8.86 | 5.4 | 87 | 65.7 | 92.6 | 81.4 | 75.4 |
| 6 | 3300 | 0.202 | 9.53 | 5.3 | 90 | 69.6 | 93.1 | 82.9 | 77.1 |
| 7 | 3480 | 0.202 | 9.98 | 5.3 | 94 | 73.5 | 93.4 | 83.4 | 77.8 |
| 8 | 3600 | 0.203 | 10.30 | 5.3 | 98 | 76.4 | 93.5 | 83.4 | 78.0 |
| 9 | 3900 | 0.204 | 11.04 | 5.3 | 105 | 83.4 | 93.8 | 84.4 | 79.2 |
| 10 | 4200 | 0.205 | 11.78 | 5.4 | 114 | 90.3 | 93.8 | 84.8 | 79.5 |
| 11 | 4500 | 0.201 | 12.50 | 5.3 | 118 | 94.6 | 94.4 | 85.3 | 80.5 |

Load Test: Torque Variation 3480 rpm

| | | | | | | | | | |
|---|---|---|---|---|---|---|---|---|---|
| 1 | 3480 | 0.104 | 9.3 | 2.8 | 47 | 37.7 | 93.3 | 85.6 | 79.8 |
| 2 | 3480 | 0.151 | 9.6 | 4.0 | 69 | 55 | 93.6 | 85.6 | 80.0 |
| 3 | 3480 | 0.202 | 9.98 | 5.3 | 94 | 73.5 | 93.4 | 83.4 | 77.8 |
| 4 | 3480 | 0.252 | 10.3 | 6.5 | 122 | 91.7 | 92.4 | 81.4 | 75.2 |

Data of a motor with a rotor according to present invention:

| | | | | | | | | | |
|---|---|---|---|---|---|---|---|---|---|
| | Rotation | | | | Input | Output | Driving | Motor | Overall |
| | Speed | Torque | Voltage | Current | Power | power | Efficiency | Efficiency | Efficiency |
| Item | (rpm) | (TQ, N-m) | (Vav) | (Iav) | (Pi) | (Po) | (Eff) | (Eff) | (Eff) |

Load Test: Rotation Speed Variation 2.0 kg-cm

| | | | | | | | | | |
|---|---|---|---|---|---|---|---|---|---|
| 1 | 1800 | 0.200 | 6.1 | 4.8 | 55 | 37.7 | 86.6 | 78.9 | 68.3 |
| 2 | 2100 | 0.199 | 7.4 | 4.8 | 61 | 44.0 | 88.5 | 81.4 | 72.0 |
| 3 | 2400 | 0.200 | 8.2 | 4.8 | 68 | 50.4 | 89.5 | 82.7 | 74.0 |
| 4 | 2700 | 0.199 | 9.2 | 4.9 | 75 | 56.3 | 90.4 | 82.9 | 74.7 |
| 5 | 3000 | 0.200 | 9.9 | 5.1 | 83 | 62.8 | 91.1 | 83.3 | 75.8 |
| 6 | 3300 | 0.204 | 10.6 | 5.1 | 92 | 70.9 | 91.9 | 84.1 | 77.2 |
| 7 | 3480 | 0.202 | 11.5 | 5.1 | 95 | 73.9 | 92.2 | 84.7 | 78.1 |
| 8 | 3600 | 0.201 | 11.6 | 5.1 | 96 | 75.7 | 92.5 | 85.0 | 78.6 |
| 9 | 3900 | 0.203 | 12.1 | 5.1 | 104 | 82.9 | 93.0 | 85.9 | 79.8 |
| 10 | 4200 | 0.200 | 13.3 | 5.0 | 109 | 88.0 | 93.3 | 86.8 | 81.0 |
| 11 | 4500 | 0.202 | 14.0 | 5.0 | 117 | 95.5 | 93.7 | 86.9 | 81.4 |

Load Test: Torque Variation 3480 rpm

| | | | | | | | | | |
|---|---|---|---|---|---|---|---|---|---|
| 1 | 3480 | 0.100 | 10.1 | 2.5 | 47 | 36.6 | 91.9 | 85.5 | 78.6 |
| 2 | 3480 | 0.150 | 10.6 | 3.5 | 70 | 54.8 | 92.4 | 85.2 | 78.7 |
| 3 | 3480 | 0.200 | 11.5 | 5.1 | 95 | 73.9 | 92.2 | 84.7 | 78.1 |
| 4 | 3480 | 0.250 | 11.8 | 6.1 | 119 | 89.9 | 91.5 | 82.8 | 75.8 |

In the test, the rotation speed is 3480 rpm and the torque is 0.2 N-m in an output end of the motor, and thus a motor efficiency is 83.4%, a driving efficiency is 93.4%, and an overall efficiency is 77.8% of the motor with the conventional rotor. Under the same circumstance, a motor efficiency is 84.7%, driving efficiency is 92.2%, and an overall efficiency is 78.1% of a motor with the rotor according to the present invention. Besides, the noise and vibration in the motor with the conventional rotor are more significant than that of the motor with the rotor according to the present invention. In addition, a total weight of magnets in the rotor according to the present invention is lessened to 71%, but the overall efficiency is still higher than the conventional rotor.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rotor for a motor, the rotor comprising:
a main body being a cylinder and comprising:
a plurality of first holes formed through the main body and annularly arranged apart from each other, an axis of each one of the first holes being parallel with a rotating axis of the main body; each one of the first holes integrally formed and extending in a bending shape, and comprising:
two arm portions;
a bent corner portion between the two arm portions and closer to the rotating axis of the main body than the two arm portions;
an air interval in the bent corner portion; and
a plurality of magnet assemblies mounted through the first holes respectively, each one of the magnet assemblies comprising:
two magnets mounted in the corresponding first hole, spaced apart by the bent corner portion of the corresponding first hole, and forming an angle between the two magnets; the angle between the two magnets being equal to an angle of the bent corner portion of the first hole.

2. The rotor as claimed in claim 1, wherein each one of the first holes comprises:
a protrusion formed on an inner wall of the first hole at the bent corner portion of the first hole; the protrusion abutting and spacing the two magnets, and thereby the air interval is between the two magnets and the protrusion.

3. The rotor as claimed in claim 1, wherein each one of the first holes comprises:
two air gaps respectively formed between in an inner wall of the first hole and two ends of the corresponding magnet assembly.

4. The rotor as claimed in claim 2, wherein each one of the first holes comprises:
two air gaps respectively formed between in the inner wall of the first hole and two ends of the corresponding magnet assembly.

5. The rotor as claimed in claim 1, wherein an angle of the bent corner portion of each one of the first holes is from 117 to 123 degrees.

6. The rotor as claimed in claim 4, wherein an angle of the bent corner portion of each one of the first holes is from 117 to 123 degrees.

7. The rotor as claimed in claim 5, wherein the angle of the bent corner portion of each one of the first holes is 120 degrees.

8. The rotor as claimed in claim 6, wherein the angle of the bent corner portion of each one of the first holes is 120 degrees.

9. The rotor as claimed in claim 1, wherein each one of the magnets of the magnet assemblies is a rectangular block.

10. The rotor as claimed in claim 8, wherein each one of the magnets of the magnet assemblies is a rectangular block.

11. The rotor as claimed in claim 1, wherein the main body further comprises:
a plurality of second holes formed through the main body and arranged closer to the rotating axis of the main body than the first holes; an axis of each one of the second holes being parallel with the rotating axis of the main body.

12. The rotor as claimed in claim 10, wherein the main body further comprises:
a plurality of second holes formed through the main body and arranged closer to the rotating axis of the main body than the first holes; an axis of each one of the second holes being parallel with the rotating axis of the main body.
